(19) United States
(12) Patent Application Publication
(10) Pub. No.: US 2014/0375442 A1
(43) Pub. Date: Dec. 25, 2014

(54) ELECTRONIC DEVICE AND METHOD FOR CONTROLLING HOUSEHOLD APPLIANCES

(71) Applicants: Fu Tai Hua Industry (Shenzhen) Co., Ltd., Shenzhen (CN); HON HAI PRECISION INDUSTRY CO., LTD., New Taipei (TW)

(72) Inventors: SHIH-FANG WONG, New Taipei (TW); XIN LU, Shenzhen (CN); HUAN-HUAN ZHANG, Shenzhen (CN); FEI WANG, Shenzhen (CN); DAN CAO, Shenzhen (CN)

(21) Appl. No.: 14/312,856

(22) Filed: Jun. 24, 2014

(30) Foreign Application Priority Data
Jun. 24, 2013 (CN) 2013102515879

(51) Int. Cl. G08C 17/02

(52) U.S. Cl. CPC G08C 17/02
USPC 340/12.53

(57) ABSTRACT

An electronic device communicates with a plurality of household appliances to execute a method to control the household appliances. A reference orientation of each household appliance relative to the electronic device is obtained and stored in a storage. When an acceleration of the electronic device exceeds a predetermined value, a movement orientation of the electronic device is detected and one or more household appliances having the reference orientation matching the movement orientation of the electronic device are displayed in a selectable image via a display. One or more household appliances selected from the selectable image can be controlled to perform corresponding functions using the electronic device according to user operations.

### CROSS-REFERENCE TO RELATED APPLICATIONS

This application claims priority to Chinese Patent Application No. 201310251587.9 filed on Jun. 24, 2013 in the China Intellectual Property Office, the contents of which are entirely incorporated by reference herein.

### FIELD

Embodiments of the present disclosure generally relate to control of household appliances, and more particularly, to a method to control household appliances using an electronic device.

### BACKGROUND

Smart household appliances, such as air-conditioners, televisions, refrigerators, washers, and other similar appliances, can be controlled using a mobile terminal such as a smart phone, a tablet computer, or other similar device.

### BRIEF DESCRIPTION OF THE DRAWINGS

Implementations of the present technology will now be described, by way of example only, with reference to the attached figures.

FIG. 1 is a diagrammatic view of an embodiment of a plurality of household appliances communicating with an electronic device in a particular area.

FIG. 2 is a block diagram of the electronic device and the plurality of household appliances of FIG. 1.

FIG. 3 is a flowchart of one embodiment of a method for controlling the household appliances using the electronic device of FIG. 2.

FIG. 4 shows orientations of the plurality of household appliances in the particular area.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to an electronic device utilized to control a plurality of smart household appliances, such as air-conditioners, televisions, refrigerators, and washers.

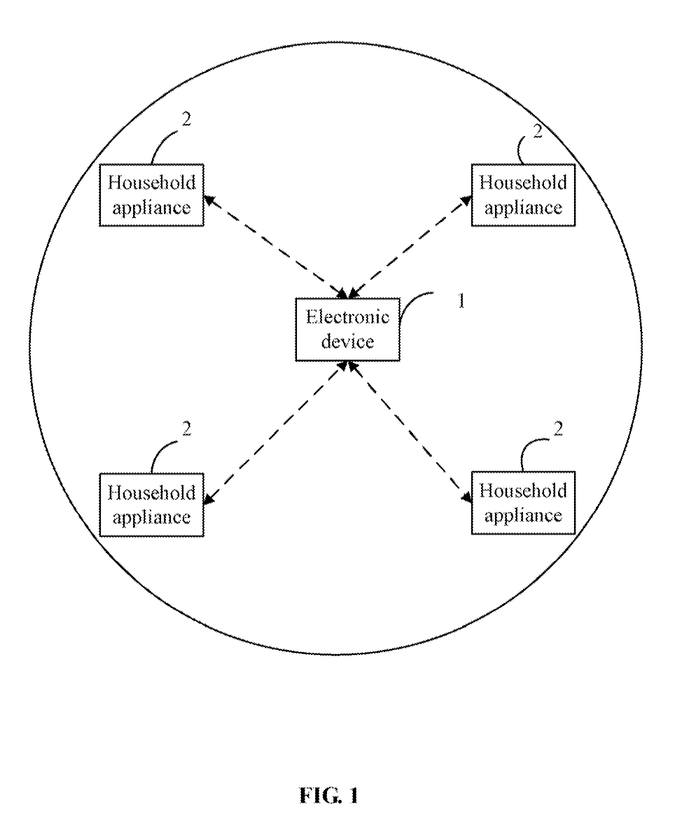

FIG. 1 shows a diagram of an embodiment of an electronic device in communication with a plurality of household appliances 2 located in particular areas. The household appliances 2 can be smart devices, such as televisions, washers, air-conditioners, refrigerators, or other similar appliances. The electronic device 1 can communicate with each of the household appliances 2 through wireless communication technologies, such as BLUETOOTH® and WIFI®. The particular area can be a room. The electronic device 1 can be a smart phone, a tablet computer, a mobile Internet device (MID), or other similar devices.

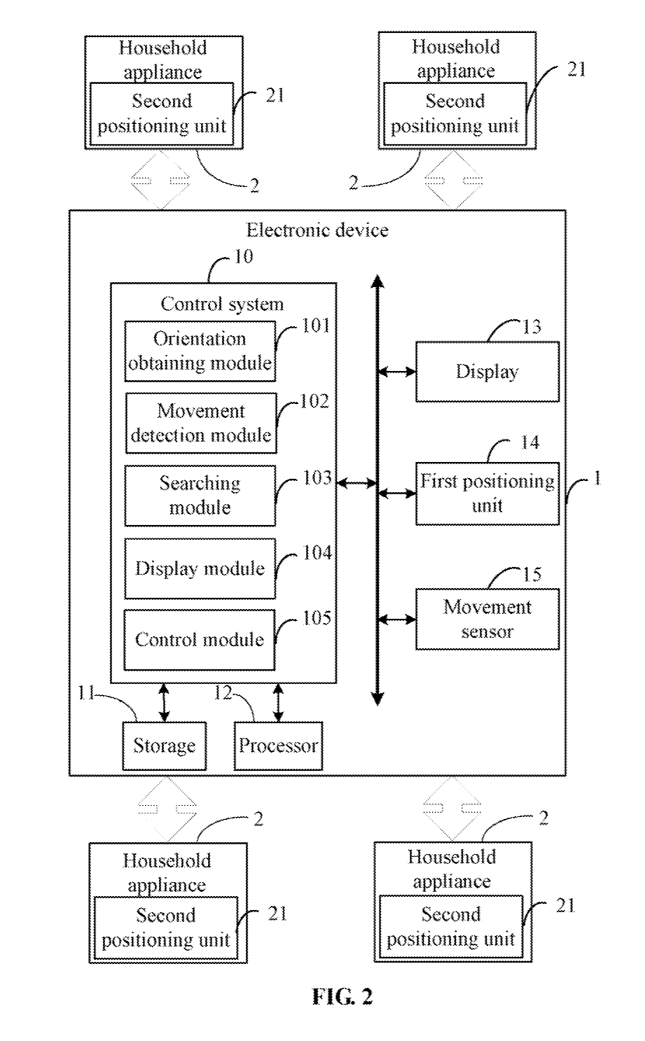

FIG. 2 illustrates a block diagram of the electronic device 1. The electronic device 1 can include a control system 10, a storage 11, a processor 12, a display 13, and a first positioning unit 14, and a movement sensor 15. Each household appliance 2 includes a second positioning unit 21. The first positioning unit 14 and the second positioning unit 21 can be global positioning systems (GPS) or radio frequency (RF) components. The movement sensor 15 can be a G-sensor. FIG. 2 illustrates one example of the electronic device 1, and the electronic device 1 can include more or fewer components than those shown in the figure, or have a different configuration of the components.

The control system 10 can include a plurality of programs in the form of one or more computerized instructions stored in the storage 11 and executed by the processor 12 to perform operations of the electronic device 1. In one embodiment, the control system 10 includes an orientation obtaining module 101, a movement detection module 102, a searching module 103, a display module 104, and a control module 105. In general, the word “module,” as used herein, refers to logic embodied in hardware or firmware, or to a collection of software instructions, written in a programming language, such as, Java, C, or assembly. One or more software instructions in the modules can be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The orientation obtaining module 101 obtains a reference orientation of each of the household appliances 2 relative to the electronic device 1 and stores the obtained reference orientation of each household appliance 2 in the storage 11. In one embodiment, the orientation obtaining module 101 can control the first positioning unit 14 to send an RF signal to the second positioning unit 21 of each household appliance 2. Then, the orientation obtaining module 101 can calculate the reference orientation of each household appliance 2 according to a response signal of the RF signal feedback from the second positioning unit 21 of each household appliance 2 using RF positioning technologies.

In another embodiment, the orientation obtaining module 101 can detect a location of the electronic device 1 using the first positioning unit 14 and send commands to the second positioning units 21 to acquire a location of each household appliance 2. Then, the orientation obtaining module 101 can calculate the reference orientation of each household appliance 2 according to the location of the electronic device 1 and the location of each household appliance 2.

The movement detection module 102 detects an acceleration of the electronic device 1 and detects a movement orientation of the electronic device 1 when the acceleration of the electronic device 1 exceeds a predetermined value. In this embodiment, the movement detection module 102 can detect the acceleration and the movement orientation of the electronic device 1 using the movement sensor 15.

The searching module 103 searches the storage 11 for one or more household appliances 2 having the reference orientation matching the movement orientation of the electronic device 1. In this embodiment, when the reference orientation of a household appliance 2 is the same or similar to the movement orientation of the electronic device 1, the reference orientation of the household appliance 2 is determined to match the movement orientation of the electronic device 1. For example, if the movement orientation of the electronic device 1 is “West”, the reference orientations of “Southwest”,

“Northwest”, and “West” are all considered to match the movement orientation of the electronic device 1.

The display module 104 controls the display 13 to display a selectable image corresponding to the matching one or more household appliances 2. Thus, a user can select one or more displayed household appliances 2 from the selectable image to control.

The control module 105 controls one or more household appliances 2 selected by the user from the selectable image to perform corresponding functions according to user operations. Further, a control menu including a plurality of options of the selected one or more household appliances 2 is displayed on the display 13, and the control signals are sent to the selected one or more household appliances 2 according the user operations applied to the options of the control menu.

In other embodiments, the control module 105 can directly send a predetermined control command to each household appliance 2 displayed on the display 13 to control each household appliance 2 to perform a corresponding function, such as powering on or powering off each displayed household appliance 2. Further, if only one household appliance 2, with a reference orientation matching the movement orientation of the electronic device 1 is searched, the control module 105 directly sends the control command to power on or power off the only one household appliance 2.

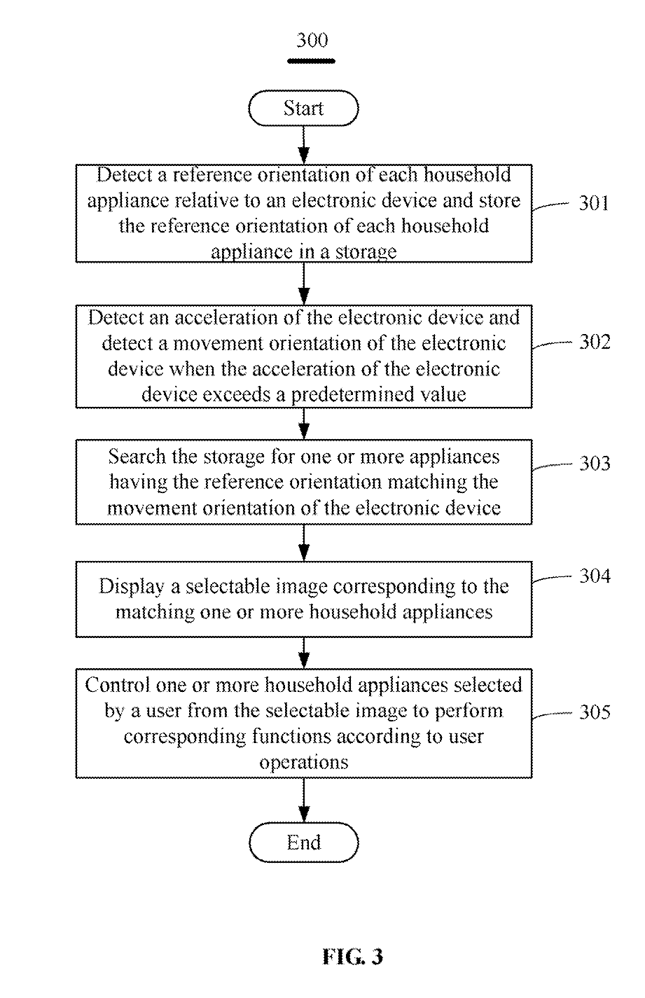

FIG. 3 illustrates a flowchart in accordance with an example method. The example method 300 is provided by way of example, as there are a variety of ways to carry out the method. The method 300 described below can be carried out using the configurations illustrated in FIG. 2, for example, and various elements of this figure are referenced in explaining example method 300. Each block shown in FIG. 3 represents one or more processes, methods or subroutines, carried out in the example method 300. Furthermore, the order of blocks is illustrative only and the order of the blocks can change according to the present disclosure. Additional blocks can be added or fewer blocks may be utilized, without departing from this disclosure. The example method 300 can begin at block 301.

At block 301, the orientation obtaining module obtains a reference orientation of each household appliance relative to the electronic device and stores the reference orientation of each household appliance in the storage.

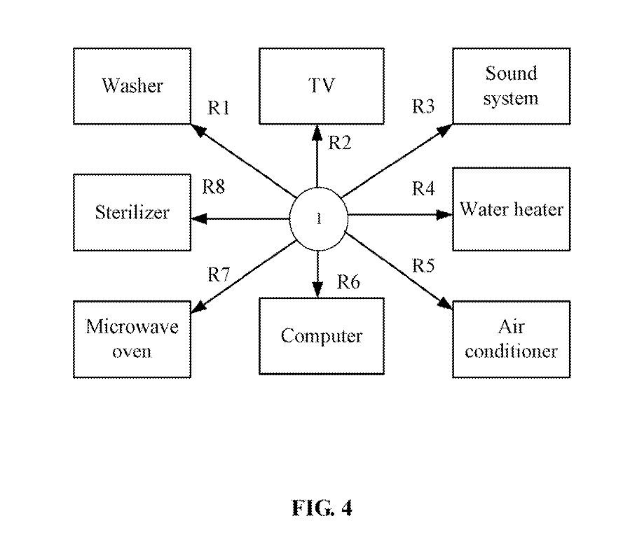

In other embodiments, the reference orientation of each household appliance can be manually preset and stored in the storage. FIG. 4 shows an example of a distribution of the plurality of household appliances in particular areas. The orientation setting module can allocate a reference orientation (e.g., R1, R2, . . . R8 as shown in FIG. 4) to each of the household appliances according to the distribution of the household appliances. Each of the orientations R1-R8 corresponds to one household appliance. For example, an air conditioner is located at the direction R5 which is Southeast of the particular areas, the reference orientation of the conditioner can be preset as “Southeast”. Accordingly, the reference orientation of a computer located at the direction R6 can be preset as “South”.

At block 302, the movement detection module detects an acceleration of the electronic device and detects a movement orientation of the electronic device when the acceleration of the electronic device exceeds a predetermined value.

At block 303, the searching module searches the storage for one or more household appliances having the reference orientation matching the movement orientation of the electronic device.

At block 304, the display module displays a selectable image corresponding to the matching one or more household appliances on the display for a user to select to control.

At block 305, the control module controls one or more household appliances selected by the user from the selectable image to perform corresponding functions according to user operations.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An electronic device communicating with a plurality of household appliances, the electronic device comprising:
a display;
a processor;
a non-transitory storage medium storing one or more programs, which when executed by the processor, cause the processor to:
obtain a reference orientation of each household appliance relative to the electronic device and store the reference orientation of each household appliance in the non-transitory storage medium;
detect an acceleration of the electronic device and detect a movement orientation of the electronic device when the acceleration of the electronic device exceeds a predetermined value;
search the non-transitory storage medium for one or more household appliances having the reference orientation matching the movement orientation of the electronic device; and
display a selectable image corresponding to the matching one or more household appliances on the display.

2. The electronic device according to claim 1, wherein the processor further controls one or more household appliances selected by the user from the selectable image to perform corresponding functions according to user operations.

3. The electronic device according to claim 1, wherein the electronic device further comprises a first positioning unit, each household appliance comprises a second positioning unit, and the processor obtains the reference orientation of each household appliance relative to the electronic device using the first positioning unit and the second positioning unit.

4. The electronic device according to claim 3, wherein the first positioning unit and the second positioning unit are radio frequency (RF) components, and the processor obtains the reference orientation of each household appliance relative to the electronic device by:
sending an RF signal to the second positioning unit of each household appliance; and
calculating the reference orientation of each household appliance according to a response signal of the RF signal feedback from the second positioning unit of each household appliance using RF positioning technologies.

5. The electronic device according to claim 3, wherein the first positioning unit and the second positioning unit are global positioning systems (GPS), and the processor obtains the reference orientation of each household appliance relative to the electronic device by:
detecting a location of the electronic device using the first positioning unit;
sending a command to the second positioning unit to acquire a location of each household appliance; and
calculating the reference orientation of each household appliance according to the location of the electronic device and the location of each household appliance.

6. The electronic device according to claim 1, wherein the reference orientation of each household appliance relative to the electronic device is manually preset and stored in the non-transitory storage medium.

7. The electronic device according to claim 2, wherein a control menu comprising a plurality of options of the one or more household appliances selected by the user is displayed on the display, and the processor sends control signals to the one or more household appliances selected by the user according to user operations applied to the options of the control menu, to control the one or more household appliances selected by the user to perform corresponding functions.

8. A method for controlling a plurality of household appliances using an electronic device, the method comprising:
obtaining a reference orientation of each household appliance relative to the electronic device and storing the reference orientation of each household appliance in a non-transitory storage medium of the electronic device;
detecting an acceleration of the electronic device and detecting a movement orientation of the electronic device when the acceleration of the electronic device exceeds a predetermined value;
searching the non-transitory storage medium for one or more household appliances having the reference orientation matching the movement orientation of the electronic device; and
displaying a selectable image corresponding to the matching one or more household appliances on the display.

9. The method according to claim 8, further comprising:
controlling one or more household appliances selected by the user from the selectable image to perform corresponding functions according to user operations.

10. The method according to claim 8, wherein the electronic device comprises a first positioning unit, each household appliance comprises a second positioning unit, and the reference orientation of each household appliance relative to the electronic device is obtained using the first positioning unit and the second positioning unit.

11. The method according to claim 10, wherein the first positioning unit and the second positioning unit are radio frequency (RF) components, and the reference orientation of each household appliance relative to the electronic device is obtained by:
sending an RF signal to the second positioning unit of each household appliance; and
calculating the reference orientation of each household appliance according to a response signal of the RF signal feedback from the second positioning unit of each household appliance using RF positioning technologies.

12. The method according to claim 10, wherein the first positioning unit and the second positioning unit are global positioning systems (GPS) and the reference orientation of each household appliance relative to the electronic device is obtained by:
detecting a location of the electronic device using the first positioning unit;
sending a command to the second positioning unit to acquire a location of each household appliance; and
calculating the reference orientation of each household appliance according to the location of the electronic device and the location of each household appliance.

13. The method according to claim 8, wherein the reference orientation of each household appliance relative to the electronic device is manually preset and stored in the non-transitory storage medium.

14. The method according to claim 9, further comprising:
displaying a control menu comprising a plurality of options of the one or more household appliances selected by the user on a display of the electronic device; and
sending control signals to the one or more household appliances selected by the user according to user operations applied to the options of the control menu, to control the selected one or more household appliances to perform corresponding functions.
